(19) United States
(12) Patent Application Publication
(10) Pub. No.: US 2017/0186367 A1
(43) Pub. Date: Jun. 29, 2017

(54) PIXEL ARRAY STRUCTURE, DISPLAY PANEL AND METHOD OF FABRICATING THE PIXEL ARRAY STRUCTURE

(71) Applicant: Industrial Technology Research Institute, Hsinchu (TW)

(72) Inventors: Yu-Hua Jhong, Pingtung County (TW); Tsu-Chiang Chang, New Taipei City (TW); Tai-Jui Wang, Kaohsiung City (TW)

(21) Appl. No.: 14/983,548

(22) Filed: Dec. 30, 2015

(30) Foreign Application Priority Data
Dec. 24, 2015 (TW) 104143653

(51) Int. Cl. G09G 3/3225; G09G 3/36

(52) U.S. Cl. CPC G09G 3/3225; G09G 3/3648; G09G 2300/0426

(57) ABSTRACT

A pixel array structure including a bottom carrier plate, a wire layer, a planarization layer, a pixel unit layer and a conductor structure is provided. The wire layer is disposed on the bottom carrier plate. The planarization layer covers the wire layer and has a flat surface at a side away from the wire layer. The pixel unit layer is disposed on the flat surface of the planarization layer. The pixel unit layer includes a pixel unit including a driving circuit structure and a pixel electrode electrically connected to the driving circuit structure. The conductor structure passes through the planarization layer and is connected between the driving circuit structure and the wire layer. A display panel having the pixel array structure and a method of fabricating the pixel array structure are also provided.

### CROSS-REFERENCE TO RELATED APPLICATION

This application claims the priority benefit of Taiwan application serial no. 104143653, filed on Dec. 24, 2015. The entirety of the above-mentioned patent application is hereby incorporated by reference herein and made a part of this specification.

### TECHNICAL FIELD

The present disclosure is related to a display panel.

### BACKGROUND

Flat display panels have become the main streamed display products in the current market. With the requirements on high resolution and high frame quality, the driving circuit structure in each pixel unit of the flat display panel becomes more complicate. For example, in a case that an organic light emitting material is used as the display medium, the driving circuit structure of each pixel unit may include more than one transistor and one or more capacitor. In addition, for transmitting variant signals, a flat display panel need be disposed with a variety of signal lines, such as scan lines, data lines, power lines, common lines and the like. Accordingly, the signal lines, the active devices, the capacitors, and the like need be disposed within a definite area, which restricts the layout design of the driving circuit structure.

### SUMMARY

A pixel array structure according to the present disclosure includes a bottom carrier plate, a wire layer, a planarization layer, a pixel unit layer and a conductor structure. The wire layer is disposed on the bottom carrier plate. The planarization layer covers the wire layer and the planarization layer has a flat surface at a side away from the wire layer. The pixel unit layer is disposed on the flat surface of the pixel unit layer and the pixel unit layer includes a pixel unit. The pixel unit includes a driving circuit structure and a pixel electrode electrically connected to the driving circuit structure. The conductor structure passes through the planarization layer and is connected between the driving circuit structure and the wire layer.

A display panel according to the present disclosure include the above mentioned pixel array structure and a display medium layer, wherein the display medium layer is disposed on the pixel unit layer and is connected to the pixel electrode.

A method of fabricating a pixel array structure according to the present disclosure includes at least the following steps. A wire layer is formed on a bottom carrier plate. A planarization layer is formed on the wire layer and the planarization layer has a flat surface at a side away from the wire layer. A pixel unit layer is formed on the planarization layer. The pixel unit layer includes a pixel unit, and the pixel unit includes a driving circuit structure and a pixel electrode electrically connected to the driving circuit structure. A conductor structure is formed. The conductor structure passes through the planarization layer and is connected between the driving circuit structure and the wire layer.

In light of the foregoing, according to the fabricating method in the present disclosure, the driving circuit structure of the pixel unit and the wires transmitting the signals are separately disposed in different layer positions in the display panel and the pixel array structure in the embodiment of the present disclosure. Accordingly, the layout space of the driving circuit structure needs not be limited and has a flexible room.

To make the above features and advantages of the present disclosure more comprehensible, several embodiments accompanied with drawings are described in detail as follows.

### BRIEF DESCRIPTION OF THE DRAWINGS

FIG. 1 is a schematic drawing of a display panel according to an embodiment of the present disclosure.

FIG. 2 is a schematic drawing showing the pixel unit layer, the wire layer, and the conductor structure in a display panel according to another embodiment of the present disclosure.

FIG. 3 is a schematic top view showing a portion of the pixel unit layer and the wire layer depicted in FIG. 2.

FIG. 4 schematically shows the cross-sectional views taken along lines I-I′, II-II′ and III-III′ in FIG. 3.

FIG. 5 is a schematic drawing showing the pixel unit layer, the wire layer, and the conductor structure in a display panel according to further another embodiment of the present disclosure.

FIG. 6 is a schematic top view showing a portion of the pixel unit layer and the wire layer depicted in FIG. 5.

FIG. 7 is a schematic drawing showing the pixel unit layer, the wire layer, and the conductor structure in a display panel according to still another embodiment of the present disclosure.

FIG. 8 is a schematic top view showing a portion of the pixel unit layer and the wire layer depicted in FIG. 7.

FIG. 9 schematically shows a cross-sectional view taken along one of the first signal lines of the wire layer in FIG. 7.

### DETAILED DESCRIPTION OF DISCLOSED EMBODIMENTS

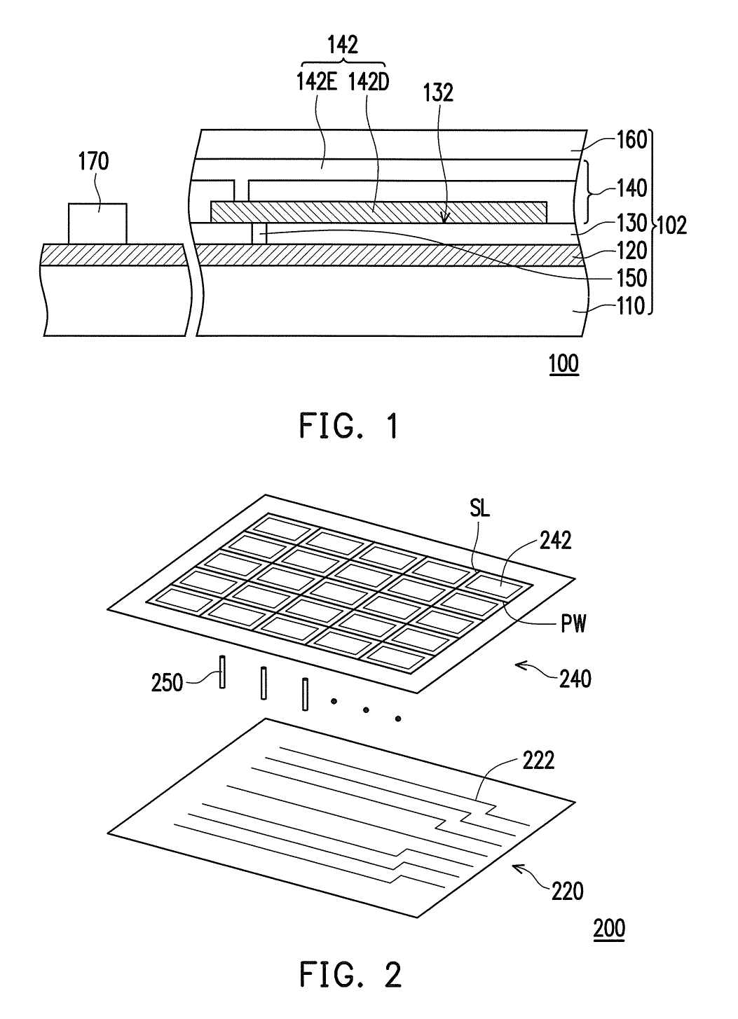

FIG. 1 is a schematic drawing of a display panel according to an embodiment of the present disclosure. Referring to FIG. 1, a display panel 100 includes a bottom carrier plate 110, a wire layer 120, a planarization layer 130, a pixel unit layer 140, a conductor structure 150, a display medium layer 160 and a signal source circuit 170, wherein the bottom carrier plate 110, the wire layer 120, the planarization layer 130, the pixel unit layer 140, and the conductor structure 150 can construct a structure named pixel array structure 102. The wire layer 120 is disposed on the bottom carrier plate 110. The planarization layer 130 covers the wire layer 120 and the planarization layer 130 has a flat surface 132 at a side away from the wire layer 120. The pixel unit layer 140 is disposed on the flat surface 132 of the planarization layer 130 and the pixel unit layer 140 includes a pixel unit 142. The pixel unit 142 includes a driving circuit structure 142D and a pixel electrode 142E electrically connected to the driving circuit structure 142D. The conductor structure 150 passes through the planarization layer 130 and is connected between the driving circuit structure 142D and the wire layer 120. The display medium layer 160 is disposed on the pixel unit layer 140 and is connected to the pixel electrode 142E. The signal source circuit 170 is electrically connected to the wire layer 120 for the pixel unit layer 130 being electrically connected to the signal source circuit 170 through the conductor structure 150 and the wire layer 120. Accordingly, the pixel unit layer 130 can receive the signals from the signal source circuit 170 to drive the display medium layer 160. In the embodiment, a material of the display medium layer 160 includes an organic light emitting material, while a liquid crystal material, electrophoresis display material, light emitting semiconductor material, or the like can be used as the display medium layer 160 in alternative embodiments.

A method of fabricating the pixel array structure 102 substantially includes the following steps. The wire layer 120 is firstly formed on the bottom carrier plate 110. Subsequently, the planarization layer 130 is formed on the wire layer 120. Thereafter, the pixel unit layer 140 is formed on the flat surface 132 of the planarization layer 130. Furthermore, in the embodiment, the conductor structure 150 passing through the planarization layer 130 is also formed, such that the conductor structure 150 is connected between the driving circuit structure 142D and the wire layer 120. The method of forming the conductor structure 150 includes forming a through hole (not shown) exposing the wire layer 120 in the planarization layer 130 and filling the through hole with a conductive material. A material of the planarization layer 130 includes inorganic insulation material, organic insulation material or a combination thereof and a tolerance on temperature of the planarization layer 130 is sufficient for suffering the fabrication temperature of the driving circuit structure 142D. In an instance, the organic insulation material for the planarization layer 130 includes polyimide, organic photoresist material or a combination thereof, and the inorganic insulation material therefor includes silicon oxide, silicon nitride, silicon oxy-nitride, or a combination thereof. In one embodiment, the planarization layer 130 can be a deposited layer or a coated layer, which is formed on the wire layer 120 by a deposition proves or a coating process. In addition, a planarization process can be selectively performed after the formation of the planarization layer 130 on the wire layer 120 so that the planarization layer 130 has the flat surface 132. The surface relief of the flat surface 132 can be determined based on variant fabrication requirements. In an embodiment, the surface relief of the flat surface 132 is acceptable as long as the yield rate of fabricating the driving circuit structure 142D thereon is not reduces.

For driving the display medium layer 160, more than one signal need be provided to the pixel unit layer 130, such as the scan signal, the data signal, the power signal, etc.). Accordingly, the wires for transmitting the signals occupy a certain proportion of the area in the whole display panel 100. In the embodiment, the wires for transmitting at least one type of the signals are configured in the wire layer 120 and the planarization layer 130 is disposed between the wire layer 120 and the pixel unit layer 140, so that the wire layer 120 and the pixel unit layer 140 are separated from each other in the thickness direction (located at variant layer positions). Therefore, the driving circuit structure 142D of a signal pixel unit 142 in the pixel unit layer 140 enjoys an enlarged layout area, which increases the design flexibility of the driving circuit structure 142D.

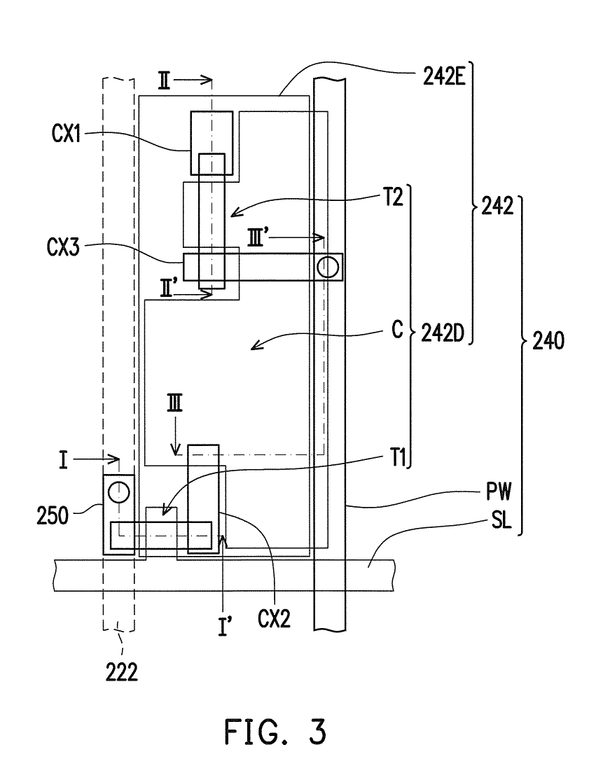

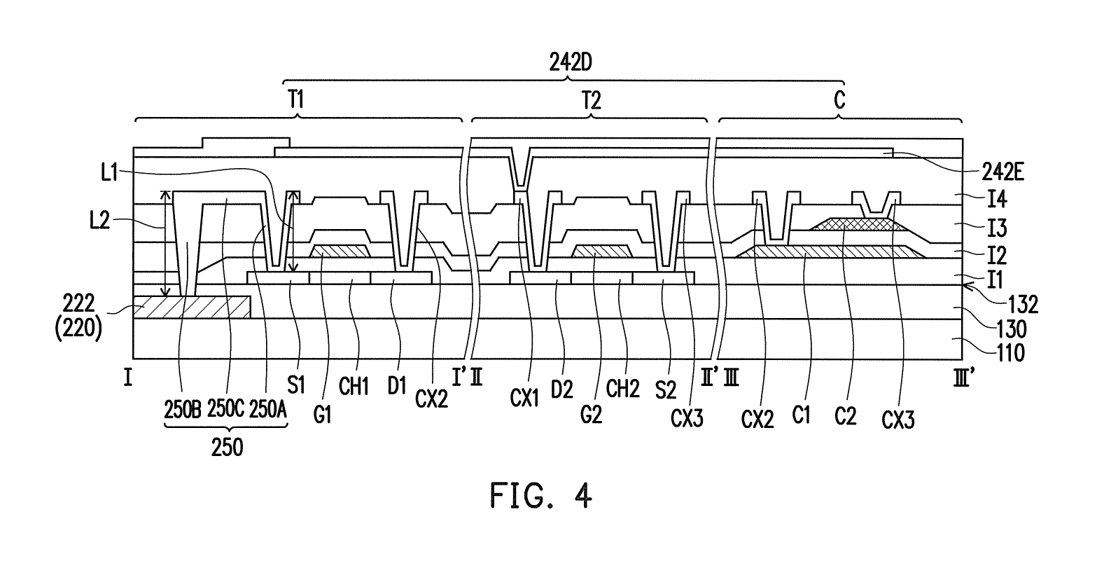

FIG. 2 is a schematic drawing showing the pixel unit layer, the wire layer, and the conductor structure in a display panel according to another embodiment of the present disclosure, FIG. 3 is a schematic top view showing a portion of the pixel unit layer and the wire layer depicted in FIG. 2, and FIG. 4 schematically shows the cross-sectional views taken along lines I-I′, II-II′ and III-III′ in FIG. 3. Referring to FIGS. 2 to 4 simultaneously, for clearing showing the designs of the wire layer 220, the pixel unit layer 240, and the conductor layer 250 in the display panel 200, other components of the display panel 200 is omitted in FIG. 2, but it is noted that the display panel 200 can further include the bottom carrier plate 110, the planarization layer 130, the display medium layer 160 and the signal source circuit 170 as described in FIG. 1. In other words, the wire layer 220, the pixel unit layer 240 and the conductor structure 250 can replace the wire layer 120, the pixel unit layer 140 and the conductor structure 150 in the display panel 100.

In the embodiment, the pixel unit layer 240 includes a plurality of pixel units 242 and the pixel units 242 are arranged in an array. The wire layer 220 includes a plurality of signal lines 222, and each of the signal lines 222 is configured corresponding to one row of the pixel units 242. Based on FIG. 3 and FIG. 4, a single pixel unit 242 includes the driving circuit structure 242D and the pixel electrode 242E connected to the driving circuit structure 242D. The driving circuit structure 242D includes a first active device T1, a second active device T2 and a capacitor structure C.

The first active device T1 includes a first gate G1, a first channel layer CH1, a first source S1 and a first drain D1, wherein the first gate G1 is separated from the first channel layer CH1 and the first source S1 and the first drain D1 are connected to the first channel layer CH1. The second active device T2 includes a second gate G2, a second channel layer CH2, a second source S2 and a second drain D2, wherein the second gate G2 is separated from the second channel layer CH2, and the second source S2 and the second drain D2 are connected to the second channel layer CH2. In addition, the second gate G2 is connected to the first drain D1 of the first active device T1 and the second drain D2 is connected to the pixel electrode 242E. A first terminal C1 of the capacitor structure C is connected to the second gate G2 and a second terminal C2 of the capacitor structure C is connected to the second source S2.

Furthermore, the pixel unit layer 240 further includes scan signal lines SL and power signal lines PW, wherein the scan signal lines SL and the power signal lines PW are collected with the signal lines 222 in the wire layer 220 for transmitting a variety of signals the driving circuit structure 242 needs. The first gate G1 of the first active device T1 is connected to the scan signal line SL and the first source S1 of the first active device T1 is connected to the signal lines 222 in the wire layer 220 through the conductor structure 250. At the same time, the second source S2 of the second active device T2 is connected to the power signal line PW. Accordingly, the driving circuit structure 242D is a 2T1C driving circuit structure consisting of two active devices and one capacitor structure and the signal lines 222 in the wire layer 220 are used for transmitting the data signal to be input into the driving circuit structure 242D. Namely, the signal lines 222 of the wire layer 220 are served as data signal lines.

For transmitting the signals from the signal source circuit (not shown) to one row of the pixel units 242, a length of the signal line 222 can continuously extend from one side of the pixel unit layer 240 to an opposite side of the pixel unit layer 240 so as to cross over the whole pixel unit layer 240. Owing that the wire layer 220 and the driving circuit structure 242D are located at two opposite sides of the planarization layer 130, the first source S1 of the first active device T1 is connected to the signal line 222 of the wire layer 220 through the conductor structure 250. Therefore, the driving circuit structure 242 can partially overlap the signal line 222 of the wire layer 220 without completely keeping away from the area of the signal line 222. In other words, the area occupied by the signal line 222 has least restriction on the layout design of the driving circuit structure 242D. Accordingly, under the same panel size with the same distribution density of the pixel units 242, the area of the active device or the capacitor structure based on the design of the embodiment can be enhanced; alternately, the driving circuit structure 242D can include more active devices or capacitor structures.

Furthermore, a plurality of components for transmitting variant signals is formed in the pixel unit layer 220 and the pixel unit layer 220 can include numbers of insulation layers I1˜I4. The insulation layer I1 is configured between the first gate G1 and the first channel layer CH1 and configured between the second gate G2 and the second channel layer CH2. The insulation layer 12 is configured between the first terminal C1 and the second terminal C2 of the capacitor structure C. The insulation layer 13 is configured between the conductor structure 250 and the first active device T1. The insulation layer I4 covers the conductor structure 250 and the pixel electrode 242E is disposed on the insulation layer I4, so that the pixel electrode 242E and the conductor structure 250 are located at two opposite sides of the insulation layer I4. In other words, the insulation layer 13 is fabricated after the fabrication of the driving circuit structure 242D to cover the driving circuit structure 242D and the conductor structure 250 is subsequently fabricated on the insulation layer 13. In addition, the connecting conductors CX1, CX2 and CX3 are fabricated at the same time as the fabrication of the conductor structure 250. The subsequently fabricated pixel electrode 242E is connected to the second drain D2 of the second active device T2 through the connecting conductor CX1. The connecting conductor CX2 is connected between the second gate G2 of the second active device T2 (or the first terminal C1 of the capacitor structure C) and the first drain D1 of the first active device T1. The connecting conductor CX3 is connected between the second source S2 of the second active device T2 and the second terminal T2 of the capacitor structure C.

Since the conductor structure 250 is fabricate after the fabrication of the pixel unit layer 240, the conductor structure 250 as shown in FIG. 4 includes a first conductor portion 250A, a second conductor portion 250B and a connecting portion 250C. The first conductor portion 250A is connected to the first source S1 of the first active device T1 in the driving circuit structure 240. The second conductor portion 250B is connected to the signal line 222 of the wire layer 220. The connecting portion 250C is connecting between the first conductor portion 250A and the second conductor portion 250B. In addition, in the embodiment, the connecting portion 250C of the conductor structure 250 and the wire layer 220 are located at two opposite sides of the driving circuit structure 240 and an extending length L1 of the first conductor portion 250A extending toward the bottom carrier plate 110 is less than an extending length L2 of the second conductor portion 250B extending toward the bottom carrier plate 110.

Furthermore, the planarization layer 130 configured between the wire layer 220 and the pixel unit layer 240 has the flat surface 132 and the first active device T1 and the second active device T2 are fabricated on the flat surface 132 of the planarization layer 130. Therefore, the quality of the first active device T1 and the second active device T2 can be ensured. Here, the first active device T1 and the second active device T2 are formed as top gate type thin film transistors, while the first active device T1 and the second active device T2 are selectively formed as a bottom gate type thin film transistors.

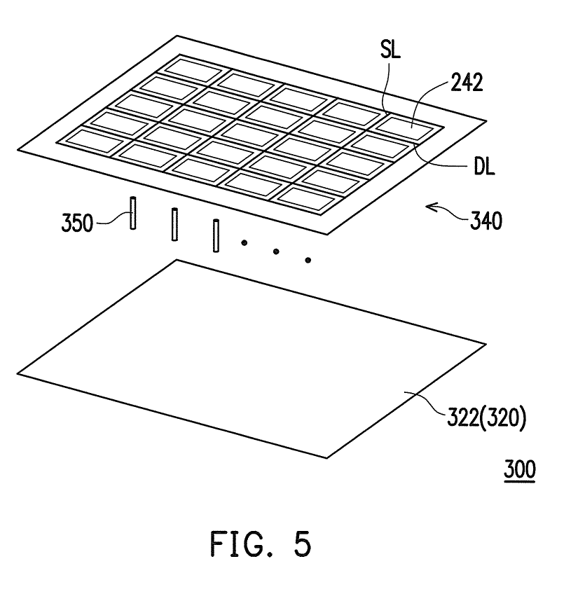

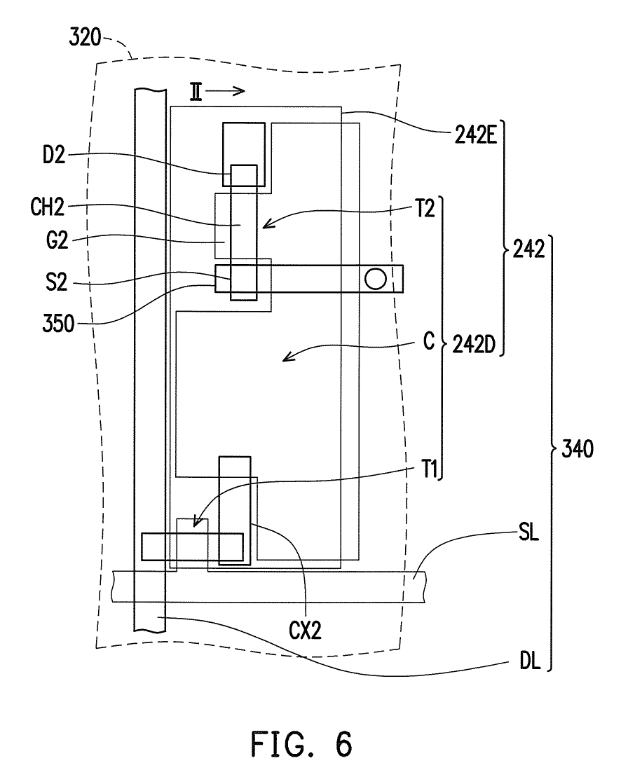

FIG. 5 is a schematic drawing showing the pixel unit layer, the wire layer, and the conductor structure in a display panel according to further another embodiment of the present disclosure and FIG. 6 is a schematic top view showing a portion of the pixel unit layer and the wire layer depicted in FIG. 5. Referring to FIG. 5 and FIG. 6 simultaneously, for clearing showing the designs of the wire layer 320, the pixel unit layer 340, and the conductor layer 350 in the display panel 300, other components of the display panel 300 is omitted in FIG. 5, but it is noted that the display panel 300 can further include the bottom carrier plate 110, the planarization layer 130, the display medium layer 160 and the signal source circuit 170 as described in FIG. 1. In other words, the wire layer 320, the pixel unit layer 340 and the conductor structure 350 can replace the wire layer 120, the pixel unit layer 140 and the conductor structure 150 in the display panel 100.

In the embodiment, the pixel unit layer 340 includes the pixel units 242 arranged in an array, a plurality of scan signal lines SL and a plurality of data signal lines DL, wherein the pixel units 242 are substantially similar to the pixel units 242 depicted in FIG. 2 to FIG. 4. The scan signal lines SL and the data signal lines DL are intersected arranged, the first gates G1 of the first active devices T1 are connected to the scan signal lines SL and the first sources S1 of the first active devices T1 are connected to the data signal lines DL. In addition, the conductor structure 350 in the embodiment is used for connecting between the wire layer 320 and the second source S2 of the second active device T2.

The wire layer 320 is used for transmitting the power signal to the second source S2 of the second active device T2. Regarding the display panel 3400, the power signal transmitted on the wire layer 320 can be provided to all the pixel units 242 at the same time. Therefore, the wire layer 320 needs not be separated into a plurality of wires. In the embodiment, the wire layer 320 can be formed by the conductive layer 322 without being patterned into a plurality of wiring patterns and the area of the whole pixel unit layer 340 can be completely located within the area of the conductive layer 322. The conductive layer 3222 is not patterned into a specified pattern, so that the conductor structure 350 can correctly connect between the conductive layer 322 and the second source S2 of the second active device T2 even if the position of the conductor structure 350 shifts from the predetermined position due to the misalignment of the fabrication. Accordingly, the wire layer 320 served as the component transmitting the power signal helps the improvement of the yield rate of fabrication. In addition, the conductive layer 322 provides the shielding effect to protect the display panel 300 from being damaged by the statistic electricity. Owing that the pixel unit layer 340 does not require including the signal lines for transmitting the power signal, the driving circuit structure 242D has larger flexibility on layout design and larger layout area.

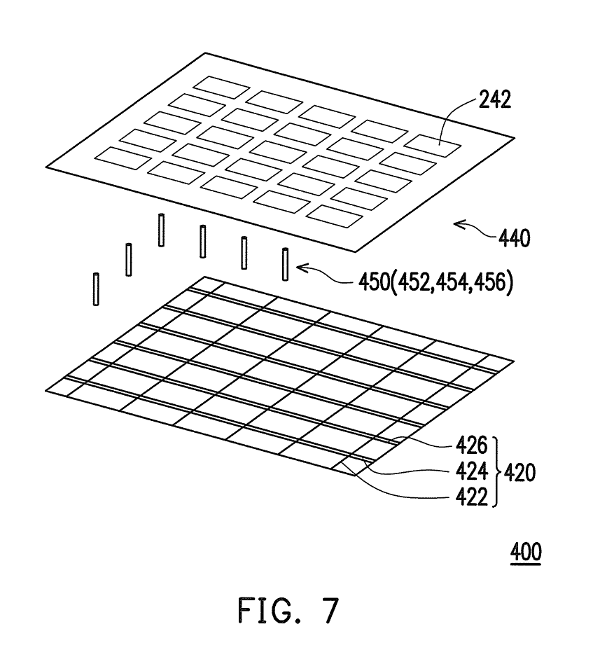

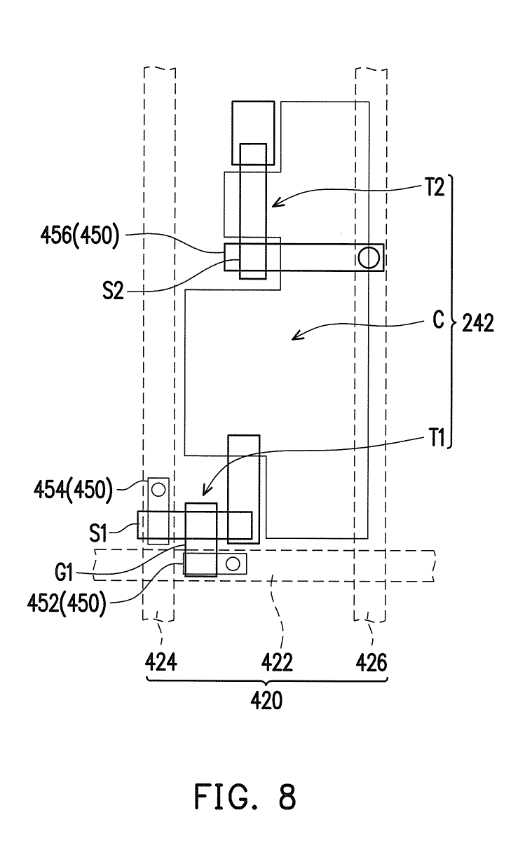

FIG. 7 is a schematic drawing showing the pixel unit layer, the wire layer, and the conductor structure in a display panel according to still another embodiment of the present disclosure, and FIG. 8 is a schematic top view showing a portion of the pixel unit layer and the wire layer depicted in FIG. 7. Referring to FIG. 7 and FIG. 8 simultaneously, for clearing showing the designs of the wire layer 420, the pixel unit layer 440, and the conductor layer 450 in the display panel 400, other components of the display panel 400 is omitted in FIG. 7, but it is noted that the display panel 400 can further include the bottom carrier plate 110, the planarization layer 130, the display medium layer 160 and the signal source circuit 170 as described in FIG. 1. In other words, the wire layer 420, the pixel unit layer 440 and the conductor structure 450 can replace the wire layer 120, the pixel unit layer 140 and the conductor structure 150 in the display panel 100.

In the embodiment, the pixel unit layer 440 includes the pixel units 242 arranged in an array, and each of the pixel units 242 is substantially similar to the pixel unit 242 described in the foregoing FIG. 2 to FIG. 4 and includes the first active device T1, the second active device T2 and the capacitor structure C. The wire layer 420 includes a plurality of first signal lines 422, a plurality of second signal lines 242 and a plurality of third signal lines 426. Each of the pixel units 242 is connected to one of the first signal lines 422, one of the second signal lines 424 and one of the third signal lines 426. The conductor structure 450 includes first connecting conductors 452, second connecting conductors 454 and third connecting conductors 456. The first connecting conductor 452 is connected between one of the first signal lines 422 and one pixel unit 242 corresponding thereto. The second connecting conductor 454 is connected between one of the second signal lines 424 and one pixel unit 242 corresponding thereto. The third connecting conductor 456 is connected between one of the third signal lines 426 and one pixel unit 242 corresponding thereto.

Specifically, as shown in FIG. 8, the first connecting conductor 452 is connected between the first gate G1 of the first active device T1 and the first signal line 422. The second connecting conductor 454 is connected between the first source S1 of the first active device T1 and the second signal line 424. The third connecting conductor 456 is connected between the second source S2 of the second active device T2 and the third signal line 426. Accordingly, the first signal line 422 can be served as a scan signal line, the second signal line 424 can be served as a data signal line and the third signal line 426 can be served as a power signal line.

In the embodiment, the wires for transmitting the scan signals, the data signals, and the power signals are configured in the wire layer 420, and the wire layer 420 and the pixel unit layer 440 are stacked in an upper and bottom manner. Therefore, in the pixel unit layer 440, none of the components in each pixel unit 242 extends outward to an area of an adjacent pixel unit 242 so that the layout space of each pixel unit 242 in the pixel unit layer 440 is not restricted by the above wires or the components of another pixel unit 242 and thus become more flexible.

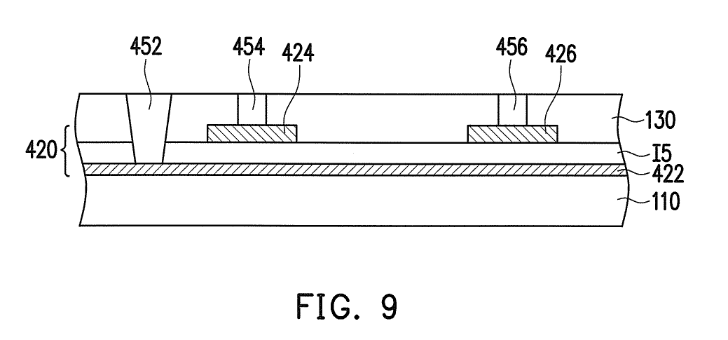

The first signal lines 422, the second signal lines 424 and the third signal lines 426 of the wire layer 420 need be electrically independent from one another and the extending direction of the first signal line 422 can be intersected with the extending directions of the second signal line 424 and the third signal line 426. As such, as shown in FIG. 9, which schematically shows a cross-sectional view taken along one of the first signal lines of the wire layer in FIG. 7, the wire later 420 can be consisted of two conductive layers and the two conductive layers are separated by an insulation layer I5. One of the two conductive layers includes the first signal lines 422 and the other includes the second signal lines 424 and the third signal lines 426. In addition, the planarization layer 130 described in FIG. 1 is disposed on the conductive layer of the second signal lines 424 and the third signal lines 426, and the first connecting conductor 452, the second connecting conductor 454 and the third connecting conductor 456 all pass through the planarization layer 130. Moreover, except for passing through the planarization layer 130, the first connecting conductor 452 further passes through the insulation layer I5 for connecting to the first signal line 422.

In view of the above, the display panel according to the embodiments in the present disclosure is configured with the wire(s) for transmitting the signals independent from the pixel unit layer, which increases the layout area of the driving circuit structure in the pixel unit and renders the layout of the driving circuit structure more flexible. Accordingly, the display panel according to the embodiment in the present disclosure has better design space.

Although the present disclosure has been described with reference to the above embodiments, it is apparent to one of the ordinary skill in the art that modifications to the described embodiments may be made without departing from the spirit of the present disclosure. Accordingly, the scope of the present disclosure will be defined by the attached claims not by the above detailed descriptions.

1. A pixel array structure comprising:
a bottom carrier plate;
a wire layer, disposed on the bottom carrier plate;
a planarization layer, covering the wire layer and having a flat surface at a side of the planarization away from the wire layer;
a pixel unit layer, disposed on the flat surface of the planarization layer, the pixel unit layer comprising a pixel unit, the pixel unit comprising a driving circuit structure and a pixel electrode electrically connected to the driving circuit structure; and
a conductor structure, passing through the planarization layer and connected between the driving circuit structure and the wire layer.

2. The pixel array structure as claimed in claim 1, wherein the driving circuit structure comprises a first active device, the first active device comprises a first gate, a first channel layer, a first source and a first drain, the first gate and the first channel layer are isolated from each other, and the first source and the first drain are connected to the first channel layer.

3. The pixel array structure as claimed in claim 2, wherein the wire layer comprises a signal line, at least one of the first gate and the first source is connected to the signal line through the conductor structure.

4. The pixel array structure as claimed in claim 3, wherein the driving circuit structure at least partially overlaps the signal line.

5. The pixel array structure as claimed in claim 2, wherein the wire layer comprises a first signal line and a second signal line, the first signal line and the second signal line are intersected with each other and electrically isolated from each other, the conductor structure comprises a first connecting conductor and a second connecting conductor, the first gate is connected to the first signal line through the first connecting conductor, and the first source is connected to the second signal line through the second connecting conductor.

6. The pixel array structure as claimed in claim 2, wherein the driving circuit structure further comprises a second active device, the second active device comprising a second gate, a second channel layer, a second source and a second drain, the second gate is connected to the first drain of the first active device and isolated from the second channel layer, the second source and the second drain are connected to the second channel layer, and the second drain is connected to the pixel electrode.

7. The pixel array structure as claimed in claim 6, wherein the wire layer comprises a conductive layer, the second source is connected to the conductive layer through the conductor structure.

8. The pixel array structure as claimed in claim 6, wherein the wire layer comprises a first signal line and a second signal line, the first signal line and the second signal line are electrically independent from each other, the conductor structure comprises a first connecting conductor and a second connecting conductor, the first source is connected to the first signal line through the first connecting conductor, and the second source is connected to the second signal line through the second connecting conductor.

9. The pixel array structure as claimed in claim 6, wherein the driving circuit structure further comprises a capacitor structure, a first terminal of the capacitor structure is connected to the second gate, and a second terminal of the capacitor structure is connected to the second source.

10. The pixel array structure as claimed in claim 1, further comprising a signal source circuit electrically connected to the wire layer, wherein the pixel unit layer is electrically connected to the signal source circuit through the conductor structure and the wire layer.

11. The pixel array structure as claimed in claim 1, wherein a material of the planarization layer comprises organic insulation material, inorganic insulation material or a combination thereof.

12. The pixel array structure as claimed in claim 11, wherein the organic insulation material comprises polyimide, organic photoresist material or a combination thereof.

13. The pixel array structure as claimed in claim 11, wherein the inorganic insulation material comprises silicon oxide, silicon nitride, silicon oxy-nitride, or a combination thereof.

14. The pixel array structure as claimed in claim 1, wherein the conductor structure comprises a first conductor portion, a second conductor portion and a connecting portion, the first conductor portion is connected to the driving circuit structure, the second conductor portion is connected to the wire layer, and the connecting portion is connected between the first conductor portion and the second conductor portion.

15. The pixel array structure as claimed in claim 14, wherein the connecting portion of the connector structure and the wire layer are located at two opposite sides of the driving circuit structure and an extending length of the first conductor portion extending toward the bottom carrier plate is less than an extending length of the second conductor portion extending toward the bottom carrier plate.

16. A display panel, comprising
the pixel array structure as claimed in claim 1; and
a display medium layer, disposed on the pixel unit layer and connected to the pixel electrode.

17. The display panel as claimed in claim 16, wherein a material of the display medium layer comprises an organic light emitting material.

18. A method of fabricating a pixel array structure, comprising:
fabricating a wire layer on a bottom carrier plate;
forming a planarization layer on the wire layer and the planarization layer having a flat surface at a side away from the wire layer;
forming a pixel unit layer on the flat surface of the planarization layer, wherein the pixel unit layer comprises a pixel unit and the pixel unit comprises a driving circuit structure and a pixel electrode electrically connected to the driving circuit structure; and
forming a conductor structure passing through the planarization layer and the conductor structure being connected between the driving circuit structure and the wire layer.

19. The method of fabricating the pixel array structure as claimed in claim 18, further forming an insulation layer covering the conductor structure, and the pixel electrode and the conductor structure being located at two opposite sides of the insulation layer.

20. The method of fabricating the pixel array structure as claimed in claim 18, wherein a through hole exposing the wire layer is further formed in the planarization layer before forming the conductor structure, and the forming the conductor structure comprises filling the through hole with a conductive material.
